(19) United States
(12) Patent Application Publication
(10) Pub. No.: US 2017/0374052 A1
(43) Pub. Date: Dec. 28, 2017

(54) COMPUTER-READABLE RECORDING MEDIUM, INFORMATION PROVISION METHOD AND INFORMATION PROVISION SYSTEM

(71) Applicant: FUJITSU LIMITED, Kawasaki-shi (JP)

(72) Inventors: Yusuke Sasaki, Kawasaki (JP); Tadahiro Uehara, Yokohama (JP); Atsuji SEKIGUCHI, Kawasaki (JP); Kosaku KIMURA, Kawasaki (JP)

(73) Assignee: FUJITSU LIMITED, Kawasaki-shi (JP)

(21) Appl. No.: 15/487,629

(22) Filed: Apr. 14, 2017

(30) Foreign Application Priority Data
Jun. 27, 2016 (JP) 2016-126748

(51) Int. Cl. H04L 29/06; H04L 29/08

(52) U.S. Cl. CPC H04L 63/083; H04L 67/42; H04L 63/0428; H04L 67/02; H04L 67/141

(57) ABSTRACT

A non-transitory computer-readable recording medium having stored therein a program that causes a computer to execute a process includes transmitting authentication information to a first server with which a communication session is to be started and acquiring session information from the first server; and transferring the acquired session information to a second server and continuing the communication session with the first server via the second server.

### CROSS-REFERENCE TO RELATED APPLICATION

This application is based upon and claims the benefit of priority of the prior Japanese Patent Application No. 2016-126748, filed on Jun. 27, 2016, the entire contents of which are incorporated herein by reference.

### FIELD

The embodiment discussed herein is related to a computer-readable recording medium, an information provision method, and an information provision system.

### BACKGROUND

In recent years, there has been an increase in the number of Web applications that realize cooperation between systems and cooperation with client terminals via a Web application programming interface (API), such as REST (REpresentational State Transfer). The Web applications standardize the user authentication and authorization mechanism by using a system, such as OAuth or SAML (Security Assertion Markup Language). There is also a growing need to introduce Web APIs to Web applications that do not use OAuth or SAML. The Web application performs authentication using Cookies and passes authentication information to an API server between a client terminal and a Web server to enable the API server to perform authentication.
Patent Document 1: International Publication Pamphlet No. WO 2011/090144
Patent Document 2: Japanese Laid-open Patent Publication No. 2004-103022
Non-Patent Document 1: “The OAuth 2.0 Authorization Framework.” Web. 28 May 2016. <URL:https://tools/ietf.org/html/rfc6749>
Non-Patent Document 2: “Security Assertion Markup Language (SAML) 2.0 Profile for OAuth 2.0 Client Authentication and Authorization Grants.” Web. 28 May 2016. <URL:https://tools.ietf.org/html/rfc7522>

The Web applications not using OAuth or SAML however have a problem in that plaintext authentication information is used everywhere when, for example, data is referred to (GET Request) and thus the risk of leakage of the authentication information increases. For example, the authentication information may remain together with the path to the accessed page in the access log in the API server. Furthermore, the authentication information may remain together with the URLs of the accessed pages in the browsing history on the Web browser.

FIG. 10 is an explanatory view illustrating exemplary communications in a conventional information provision system. As illustrated in FIG. 10, a conventional information provision system 200 includes a client terminal 210, an API server 220 and a Web server 230. The client terminal 210 starts a communication session with the Web server 230 via the API server 220 and browses information. The API server 220 performs authentication on an access to the Web server 230 by using authentication information that is obtained from the client terminal 210 and starts a communication session.

For example, when the authentication information is transmitted from the client terminal 210 to the API server 220 by using Basic authentication and authentication for the Web server 230 is performed, plaintext authentication information is dealt with also in the API server 220. This increases the risk of leakage of the authentication information.

When the authentication information is incorporated in a GET parameter and is transmitted, in other words, when the authentication information is incorporated in the request path, the authentication remains together with the path to the accessed page in the access log in the API server 220. Furthermore, the authentication information remains together with the URL (uniform resource locator) of the accessed page also in the browsing history in the Web browser of the client terminal 210 and thus the risk of leakage of the authentication information increases.

In the case of the GET request, the authentication information is on the request path because most of libraries do not allow a request parameter to be incorporated in a message-body. In the case of a POST request used to, for example, update data, the request parameter is incorporated in the message body and thus the authentication information does not remain in the access log; however, the authentication information is still stored in the API server 220 and thus the risk of leakage of the authentication information increases.

### SUMMARY

According to an aspect of an embodiment, a non-transitory computer-readable recording medium stores therein a program that causes a computer to execute a process including transmitting authentication information to a first server with which a communication session is to be started and acquiring session information from the first server; and transferring the acquired session information to a second server and continuing the communication session with the first server via the second server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram exemplifying an information provision system according to an embodiment;

FIG. 2 is a flowchart of exemplary operations of the information provision system according to the embodiment;

FIG. 3 is an explanatory view illustrating an authentication screen access;

FIG. 4 is an explanatory view illustrating an access to transfer a Cookie;

FIG. 5 is an explanatory view illustrating a response from a Web server;

FIG. 6 is an explanatory view illustrating a response from a Web server;

FIG. 7 is an explanatory view illustrating a flow from a request to a display;

FIG. 8 is an explanatory view illustrating exemplary communications in the information provision system according to the embodiment;

FIG. 9 is a block diagram exemplifying a hardware configuration of a client terminal, an API server, and a Web server; and

FIG. 10 is an explanatory view illustrating exemplary communications of a conventional information provision system.

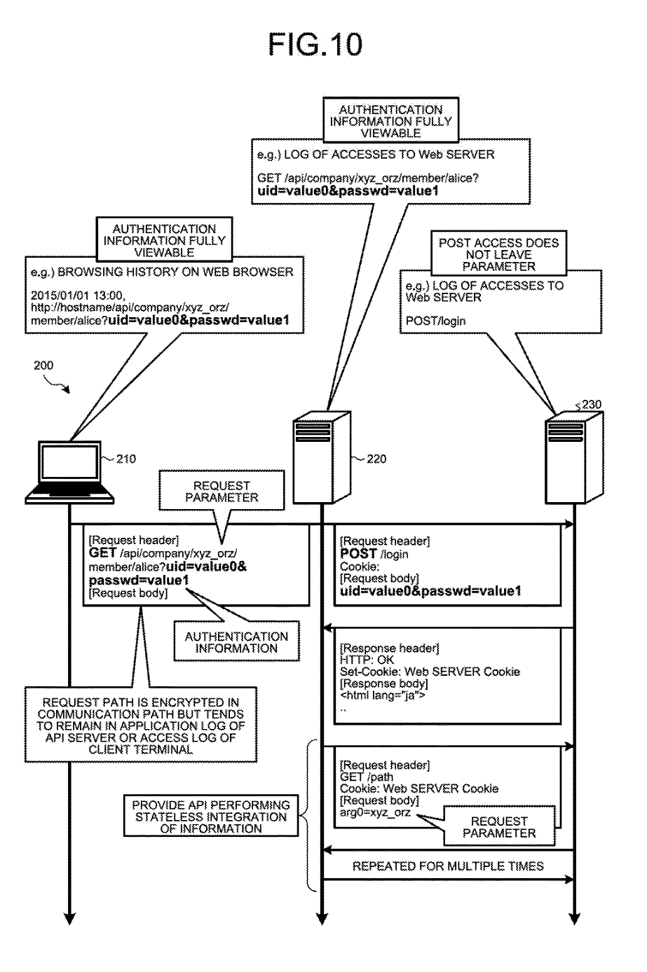

### DESCRIPTION OF EMBODIMENT

Preferred embodiments of the present invention will be explained with reference to accompanying drawings. The same reference numerals denote the same components having the same functions in the embodiment and redundant descriptions will be omitted below. The computer-readable recording medium, the information provision method and the information provision system according to the embodiment to be described below are examples only and do not limit the embodiments. The following embodiments may be combined within a range where no discrepancy is caused.

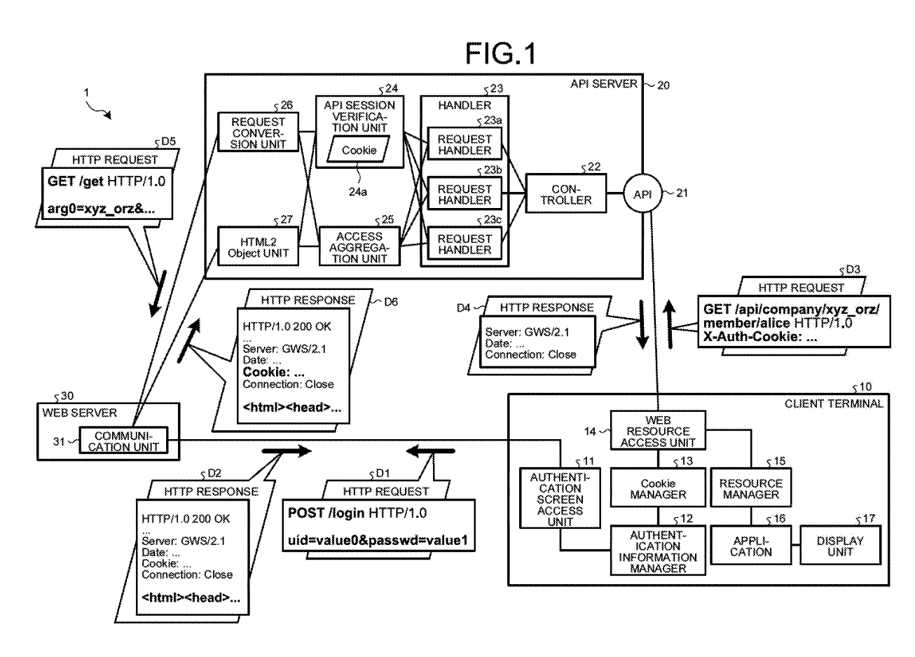

FIG. 1 is a block diagram exemplifying the information provision system according to the embodiment. As illustrated in FIG. 1, an information provision system 1 includes a client terminal 10, an API server 20 and a Web server 30.

The client terminal 10 is, for example, a personal computer (PC) or a tablet terminal. The client terminal 10 executes a Web application, such as a Web browser, to access the Web server 30 according to the HTTP (HyperText Transfer Protocol) and displays information that is provided by the Web server 30 to the user. For example, after establishing a communication session with the Web server 30, the client terminal 10 requests the Web server 30 to provide information, obtains a response (reply) to the request, and displays the information provided from the Web server 30 to the user.

The client terminal 10 includes an authentication screen access unit 11, authentication information manager 12, a Cookie manager 13, a Web resource access unit 14, a resource manager 15, an application 16 and a display unit 17.

The authentication screen access unit 11 transmits a request D1 to the Web server 30, receives a response D2 from the Web server 30, and executes an authentication process to establish a communication session with the Web server 30.

Specifically, the authentication screen access unit 11 accesses an authentication screen (a login screen) of the Web server 30 and transmits a request D1 that is a POST request in which authentication information, such as the user ID and a password, that is input on the authentication screen is used as a parameter.

The Web server 30 refers to a DB (not illustrated) that manages pre-registered authentication information in accordance with authentication information that is contained in the request D1 and determines whether the authentication is successful or fails. The Web server 30 then makes a response D2 containing a response screen corresponding to the determination result. When the authentication is successful, the Web server 30 incorporates a Cookie (session information) on a communication session between the Web server 30 and the client terminal 10 in the response D2 and makes the response. Accordingly, when the authentication is successful, the authentication screen access unit 11 acquires the Cookie (session information) from the Web server 30.

The authentication screen access unit 11 uses an encrypted communication path as a communication path via which the request D1 is transmitted to the Web server 30 and the response D2 is received from the Web server 30, in other words, the path via which the authentication information is transmitted to the Web server 30 and the session information is acquired. Specifically, SSL (Secure Sockets Lyer)/TLS (Transport Layer Security) is implemented in the authentication screen access unit 11 and the authentication screen access unit 11 transmits the request D1 and receives the response D2 by using the communication path that is encrypted according to SSL/TLS. This makes it possible to prevent leakage of the authentication information in communications with the Web server 30.

The authentication information manager 12 manages the user authentication information, such as the user ID and the password that are input by the authentication screen access unit 11. The Cookie manager 13 manages the Cookie (session information) that is acquired by the authentication screen access unit 11 from the Web server 30.

The Web resource access unit 14 transmits a request D3 to an API 21 of the API server 20 and receives a response D4 from the API 21 and accesses a Web resource that is provided by the Web server 30 via the API server 20.

Specifically, the Web resource access unit 14 reads the Cookie (session information) that is acquired from the Web server 30 from the Cookie manager 13 and transfers the Cookie to the API server 20 to continue the communication session with the Web server 30 via the API server 20, which enables an access to the Web resource that is provided by the Web server 30.

The Web resource access unit 14, for example, transmits the request D3 that is a GET request in which, for example, the Cookie is used as a parameter to the API 21 of the API server 20. Because of the transfer of the Cookie, the API server 20 is permitted to access the Web server 30 according to the authenticated user authority and accordingly it is possible to provide the Web resource that is provided by the Web server 30 to the client terminal 10 via the API server 20. The Web resource that is provided by the Web server 30 includes, for example, a task database (DB) that manages customer information and purchase information that are accessed from various sites and used.

The resource manager 15 manages the Web resource that is acquired by the Web resource access unit 14 via the API server 20. The application 16 is an application logic unit in the Web application that performs various logical processes. For example, the application 16 performs a process of processing the acquired Web resource to drawing data. The display unit 17 is a processor that performs a display process on, for example, the monitor and displays the result of the process performed by the Web application, such as display of the Web resource that is processed for drawing.

The API server 20 includes the API 21, a controller 22, a handler 23, an API session verification unit 24, an access aggregation unit 25, a request conversion unit 26 and an HTML2Object unit 27.

The API 21 is an interface that accepts an access to the Web resource of the Web server 30. Specifically, the API 21 receives the request D3 from the Web resource access unit 14 and outputs the received request D3 to the controller 22. The API 21 further transmits a reply result from the Web server 30 that is output from the controller 22 in response to the request D3 as the response D4 to the client terminal 10.

The controller 22 receives the request D3 from the API 21 and temporarily stores the content including the header and the body contained in the request D3. Specifically, the controller 22 extracts, for example, the type of the request, such as a GET request, (request method), the path to the Web resource to be requested, such as a URL, and a Cookie 24a (session information) from the request D3 and temporarily stores them in a memory. The handler 23 deals with request handlers 23a to 23c corresponding to the requests D3 that are temporarily stored by the controller 22 in the memory.

The API session verification unit 24 incorporates the Cookie 24a, which is contained in the request D3, into a request D5 to the Web server 30 and transmits the request D5 and, on the basis of the content of a response D6 to the request D5, verifies the communication session between the API server 20 and the Web server 30. Specifically, the API session verification unit 24 analyzes an authentication response screen contained in the response D6 and determines whether the authentication is successful or the authentication fails. When the authentication fails, the API session verification unit 24 cause the API 21 to transmit the response D4 indicating that the authentication fails to the client terminal 10. When the authentication is successful, the response D4 indicating that the authentication is successful is not transmitted to the client terminal 10 and the communication session with the Web server 30 is continued.

The access aggregation unit 25 aggregates accesses to the Web server 30 that are dealt with by the request conversion unit 26 and the HTML2Object unit 27 with respect to sets of requests handled by the respective request handlers 23a to 23c. Specifically, the access aggregation unit 25 aggregates the content of the responses D6 that are received by the HTML2Object unit 27 after the request conversion unit 26 transmits the requests D5 to the Web server 30 with respect to sets of requests handled by the respective request handlers 23a to 23c and outputs the content to the handler 23. Accordingly, the API 21 transmits the result obtained by aggregating the responses D6 from the Web server 30 with respect to the requests handled by the request handlers 23a to 23c as the response D4 to the client terminal 10.

The request conversion unit 26 transmits the request D5 corresponding to the request D3, which is received from the client terminal 10, to the Web server 30. Specifically, the request conversion unit 26 uses the Cookie 24a contained in the request D3 as a parameter and transmits the request D5 that is a GET request.

The HTML2Object unit 27 receives the response D6 from the Web server 30 to the request D5 and passes the response D6 to the access aggregation unit 25. The HTML2Object unit 27 processes the content contained in the body of the received response D6 to a common format (such as JSON) readable by the client terminal 10 and then passes the response D6 to the access aggregation unit 25.

The Web server 30 includes a communication unit 31 that is a communication interface in the Web server 30 and to which a given network address is assigned. The Web server 30 provides various types of information to an external device, such as the client terminal 10 that establishes a communication session with the communication unit 31. For example, the Web server 30 makes a response to a request according to the HTTP and provides information described in, for example, HTML (HyperText Markup Language).

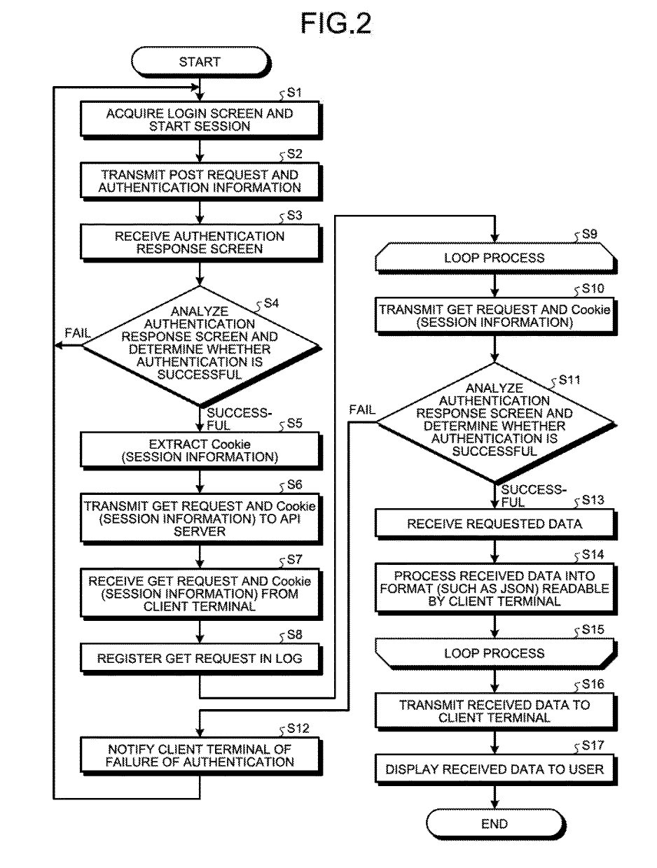

FIG. 2 is a flowchart of exemplary operations of the information provision system 1 according to the embodiment. As illustrated in FIG. 2, when the process is started, the authentication screen access unit 11 of the client terminal 10 transmits the request D1 to the Web server 30, receives the response D2, accordingly acquires the login screen (authentication screen) and starts a communication session with the Web server 30 (S1).

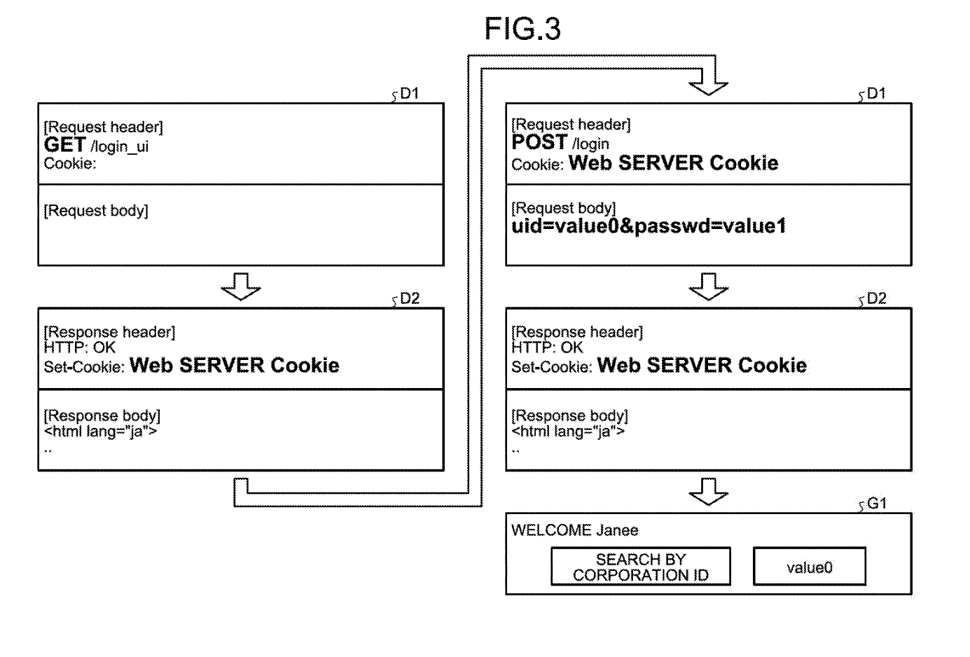

FIG. 3 is an explanatory view illustrating an authentication screen access. As illustrated in FIG. 3, at S11, the authentication screen access unit 11 transmits the request D1 that is a GET request on the login screen to the Web server 30 and receives the response D2 on the login screen from the Web server 30. The authentication screen access unit 11 extracts the Cookie that is contained in the response D2 and outputs the Cookie to the Cookie manager 13. When a token preventing impersonation by cross site request forgeries (CSRF) is transmitted from the Web server 30, the authentication screen access unit 11 extracts the prevention token together with the Cookie and outputs the prevention token and the Cookie to the Cookie manager 13.

The authentication screen access unit 11 transmits the request D1 that is a POST request containing authentication information, such as the user ID and the password that are input by the user, that is managed by the authentication information manager 12 to the Web server 30 (S2). The authentication screen access unit 11 then receives the response D2 containing a response screen corresponding to the result of the determination based on the authentication information from the Web server 30 (S3).

Specifically, as illustrated in FIG. 3, at S2, the authentication screen access unit 11 transmits the request D1 in which, for example, “uid” and “passwd” are set to the Web server 30. At S3, the authentication screen access unit 11 receives the response D2 containing the response screen corresponding to the result of determination on “uid” and “passwd” from the Web server 30.

The authentication screen access unit 11 analyzes the authentication response screen contained in the response D2 and determines whether the authentication is successful (S4). For example, when an error code indicating a failure of the authentication is contained, the authentication screen access unit 11 determines that the authentication fails. When the error code indicating a failure of the authentication is not contained, the authentication screen access unit 11 determines that the authentication is successful.

At S4, when the authentication fails, the authentication screen access unit 11 returns to the process at S1. When the authentication fails, the Web server 30 recognizes that the authentication on the communication session with respect to the Cookie transmitted to the client terminal 10 fails (the login is unaccepted).

When the authentication is successful at S4, the response screen contained in the response D2 is displayed by the display unit 17 to the user. For example, when the authentication is successful, as illustrated in FIG. 3, a display screen G1 of the display unit 17 displays a user portal screen that is a response screen to the user who is successfully authenticated. The user performs an operation on the display screen G1 to request various Web resources that are provided by the Web server 30. The Web server 30 recognizes that the authentication is successful (the user logging in) in the communication session corresponding to the Cookie that is transmitted to the client terminal 10 and continues the communication session.

When the authentication is successful at S4, the authentication screen access unit 11 extracts the Cookie contained in the response D2 (S5) and outputs the Cookie to the Cookie manager 13. Accordingly, the Cookie corresponding to the communication session in which the authentication is successful in the Web server 30 (the user logging in) is managed by the Cookie manager 13.

The Web resource access unit 14 receives a request for various Web resources provided by the Web server 30 from the user that is made by, for example, operations on the display screen G1 (refer to FIG. 3). The Web resource access unit 14 then transmits a GET request on the Web resources requested by the user and the Cookie (session information) for the user logging in to the API server 20 (S6).

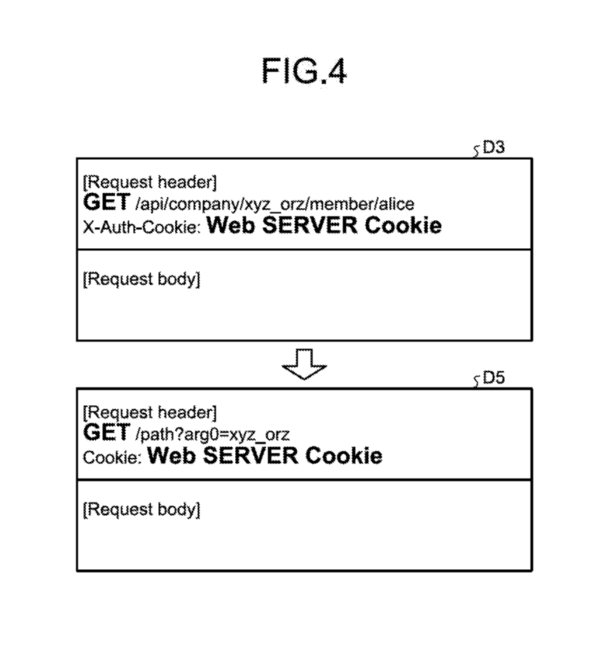

FIG. 4 is an explanatory view illustrating an access to transfer the Cookie. As illustrated in FIG. 4, at S6, the Web resource access unit 14 transmits the request D3 that is the GET request in which the Cookie (session information) for the user logging in is a parameter to the API 21 of the API server 20 In the GET request, the resource path to the Web resource requested by the user is incorporated together with the Cookie of the Web server 30.

The controller 22 of the API server 20 receives the GET request and the Cookie (session information) from the client terminal 10 (S7) and registers the GET request in the log (S8). The API server 20 preforms a loop process from S9 to S15 on an access to the Web server 30 according to the request D3.

In the exemplary request D3 illustrated in FIG. 4, the request path is “api/company/xyz_orz/member/alice”. Thus, in the loop process from S9 to S15, the information on “alice” of “member” belonging to “company” of “xyz_orz” is accessed.

When the loop process is started, the request conversion unit 26 transmits the GET request corresponding to the request D3 and the Cookie (session information) to the Web server 30 (S10). Specifically, as illustrated in FIG. 4, at S10, the request conversion unit 26 transmits the request D5 including the Cookie (session information) contained in the request D3 and a request path to the Web server 30. In other words, by transferring the Cookie (session information) contained in the request D3 of the client terminal 10 to the Web server 30, the request conversion unit 26 accesses the Web server 30 in accordance with the authority of the authenticated user. The request D5 may be in, for example, a given REST format representing an access to the request path of “api/company/xyz_orz/member/alice”.

The HTML2Object unit 27 receives body data D7 corresponding to the request D5. The API session verification unit 24 analyzes the authentication response screen contained in the response D6 and determines whether the authentication is successful (S11). For example, when an error code indicating the failure of the authentication is contained, the API session verification unit 24 determines that the authentication fails. When the error code indicating the failure of the authentication is not contained, the API session verification unit 24 determines that the authentication is successful.

When the authentication fails at S11, the API session verification unit 24 causes the API 21 to transmit the response D4 to which the error code indicating the failure of the authentication to the client terminal 10 to notify the client terminal 10 of the failure of the authentication (S12).

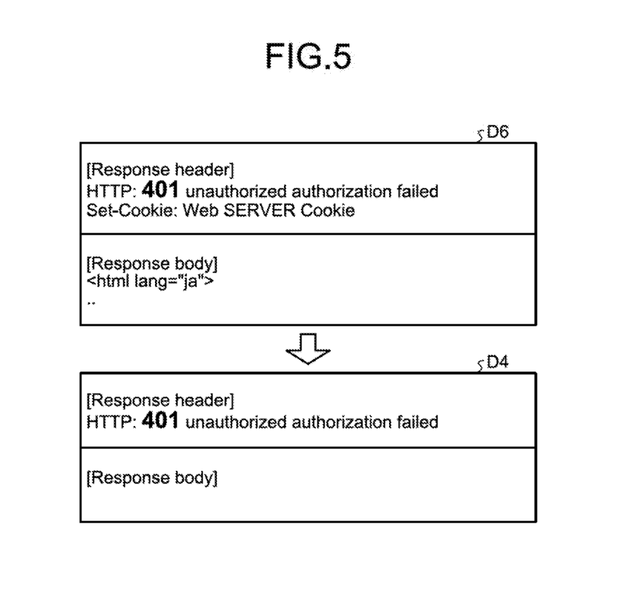

FIG. 5 is an explanatory view illustrating a response from the Web server 30 and, more specifically, is a diagram illustrating a response made when the authentication fails.

As illustrated in FIG. 5, when the authentication according to the Cookie (session information) fails, the Web server 30 notifies the API server 20 of the response D6 representing an error code such as “401”. In this case, the API session verification unit 24 causes the API 21 to transmit the response D4 to which the error code of “401” is given to the client terminal 10 to notify the client terminal 10 of the failure of the authentication.

As the authentication according to the Cookie (session information) fails and the communication session is cut off and thus, the client terminal 10 that receives the notification indicating the failure of the authentication returns to the process at S1 in order to retry the login authentication.

When the authentication is successful at S11, the HTML2Object unit 27 receives the requested data (HTML document), that is, the response D6 to the request D5 (S13). The HTML2Object unit 27 then processes the received data into a format (such as JSON) readable by the client terminal 10 (S14).

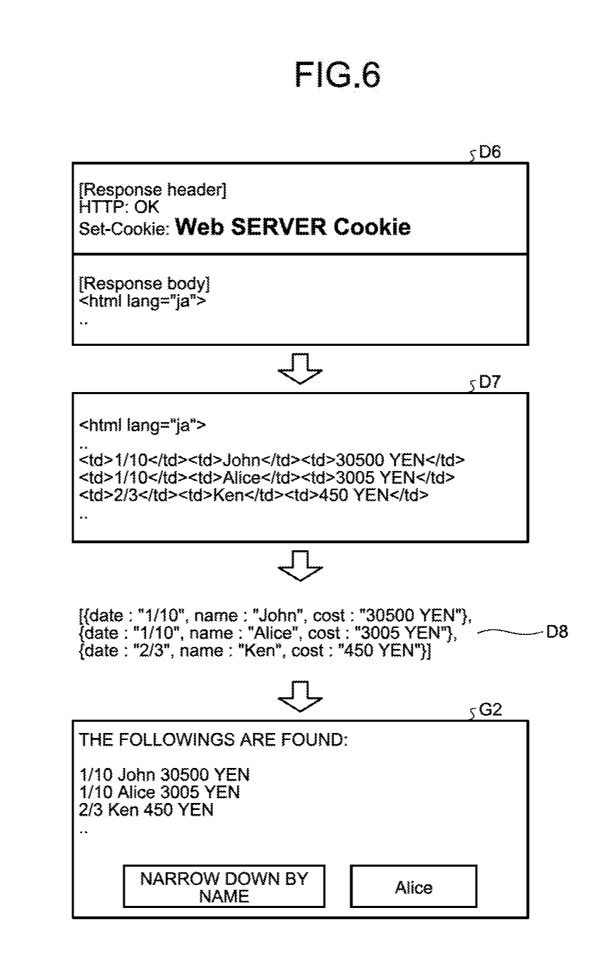

FIG. 6 is an explanatory view illustrating a response from the Web server 30 and, more specifically, is a diagram illustrating a response made when the authentication is successful. As illustrated in FIG. 6, when the authentication according to the Cookie (session information) is successful, the Web server 30 notifies the API server 20 of the response D6 containing the requested data (HTML document). The HTML2Object unit 27 creates the processed data D8 obtained by processing data into a given format, such as JSON, on the basis of the body data D7 in which the HTML document in the response D6 is stored. The client terminal 10 obtains the processed data D8 and thus is able to draw the display screen G2 of the requested data.

The access aggregation unit 25 continues the loop process (S9 to S15) until all the data requested by the request D3 is obtained from the Web server 30, aggregates the obtained data, and outputs the aggregated data to the handler 23.

The API 21 transmits the data that is received from the Web server 30 (the processed data D8) as the response D4 to the client terminal 10 (S16). The resource manager 15 of the client terminal 10 performs a process of, for example, processing the processed data D8 contained in the response D4 into drawing data (in given drawing size and color) (for example, into the Map format). The display unit 17 then displays the data processed by the resource manager 15 to the user (S17).

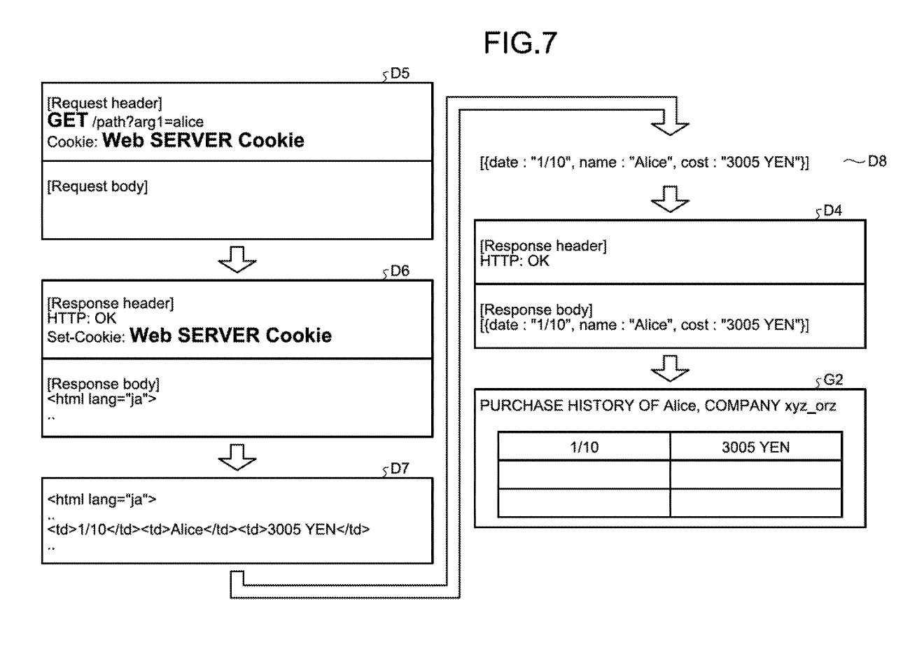

FIG. 7 is an explanatory view illustrating the flow from the request to the display. As illustrated in FIG. 7, the API server 20 obtains the processed data D8 on the basis of the body data D7 contained in the response D6 to the request D5 to the Web server 30. The API server 20 then transmits the response D4 in which the obtained processed data D8 is set in the body to the client terminal 10. The client terminal 10 receives the response D4, displays the Web resource obtained from the Web server 30 on the display screen G2 of the display unit 17 to display the Web resource to the user.

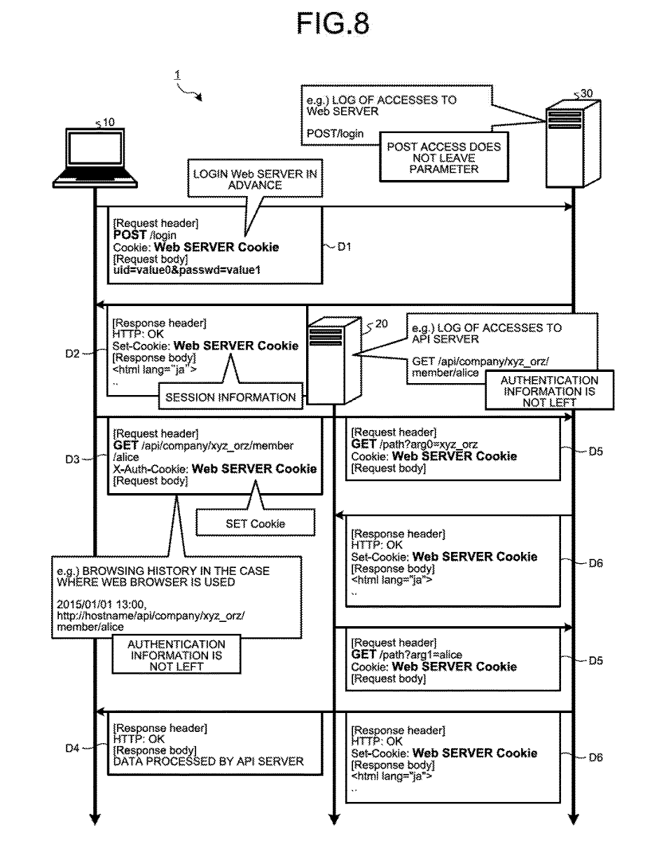

FIG. 8 is an explanatory view illustrating exemplary communications in the information provision system 1 according to the embodiment. As illustrated in FIG. 8, the client terminal 10 transmits the authentication information to the Web server 30 with which a communication session is to be started (D1) and acquires the session information (Cookie) from the Web server 30 (D2). The client terminal 10 transfers the acquired session information to the API server 20 (D3) and continues the communication session with the Web server 30 via the API server 20 (D5, D6 and D4). Accordingly, the client terminal 10 is able to receive the provision of the Web resource via the API server 20 from the Web server 30 without passing the authentication information to the API server 20, which lowers the risk of leakage of the authentication information.

For the check on the communication session via the API server 20 after the login authentication, it suffices if the Web server 30 performs the conventional check using the Cookie. It is thus possible for the Web server 30 to provide services without modifying the conventional system. For example, the Web server 30 does not need to make a modification, such as, acceptance of login authentication from the API server 20.

The components of each device illustrated in the drawings do not necessarily need to be configured physically as illustrated in the drawings. In other words, specific modes of dispersion and integration of each device are not limited to that illustrated in the drawings and all or part of the components may be configured by functionally or physically being dispersed or integrated according to any unit in accordance with various types of load or the use situation.

All or part of the various processing functions implemented by the client terminal 10, the API server 20 and the Web server 30 may be implemented on a CPU (or a microcomputer, such as a MPU or a micro controller unit (MCU)). Needless to say, all or part of the various process functions may be implemented on a program that is analyzed and executed by a CPU (or a microcomputer, such as a MPU or a micro controller unit (MCU)) or on hardware using a wired logic. The various processing functions implemented by the API server 20 and the Web server 30 may be implemented by multiple computers in cooperation with one another by cloud computing.

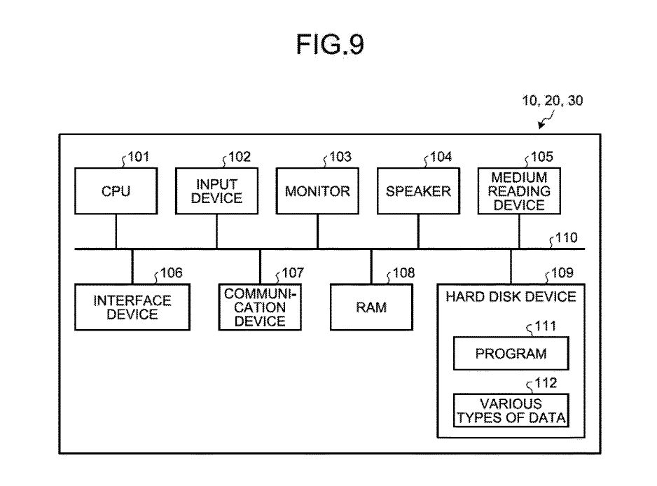

The various processes of the embodiment described above may be realized by executing a program prepared in advance with a computer. An exemplary computer (hardware) that executes the program having the functions equivalent to those of the embodiment will be described. FIG. 9 is a block diagram exemplifying the hardware configuration of the client terminal 10, the API server 20, and the Web server 30 according to the embodiment. The exemplary hardware configuration of the client terminal 10 will be described below as a representative.

As illustrated in FIG. 9, the client terminal 10 includes a CPU 101 that executes various arithmetic operations, an input device 102 that receives data inputs, a monitor 103, and a speaker 104. The client terminal 10 includes a medium read device 105 that reads, for example, a program from a recording medium, an interface device 106 for connections to various devices, and a communication device 107 for a wired or wireless connection to an external device for communications. The client terminal 10 includes a RAM 108 that temporarily stores various types of information and a hard disk device 109. The components (101 to 109) of the client terminal 10 are connected to a bus 110.

The hard disk device 109 stores a program 111 for executing various processes performed by the authentication screen access unit 11, the authentication information manager 12, the Cookie manager 13, the Web resource access unit 14, the resource manager 15, the application 16, and the display unit 17. The hard disk device 109 stores various types of data 112 referred by the program 111. The input device 102, for example, receives an input of operation information from the operator of the information provision system 1. The monitor 103, for example, displays various screens operated by the operator. To the interface device 106, for example, the printing device is connected. The communication device 107 is connected to a communication network, such as a local area network (LAN), and communicates various types of information with an external device via the communication network.

The CPU 101 reads the program 111 that is stored in the hard disk device 109, loads the program 111 into the RAM 108, and executes the program, thereby performing various processes. The program 111 is not necessarily stored in the hard disk device 109. For example, the client terminal 10 may read the program 111 that is stored in a recording medium readable by the client terminal 10 and execute the program 111. The storage medium readable by the client terminal 10 corresponds to, for example, a portable recording medium, such as a CD-ROM, a DVD disk, a universal serial bus (USB) memory, a semiconductor memory, such as a flash memory, or a hard disk drive. The program 111 may be stored in a device that is connected to, for example, the public line, the Internet, or a LAN, and the client terminal 10 may read the program 111 from the device and execute the program 111.

According to the first embodiment, it is possible to reduce the risk of leakage of the authentication information.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
transmitting authentication information to a first server with which a communication session is to be started and acquiring session information from the first server; and
transferring the acquired session information to a second server and continuing the communication session with the first server via the second server.

2. The non-transitory computer-readable recording medium according to claim 1, wherein
the session information is a Cookie, and
the continuing includes transferring the Cookie to the second server.

3. The non-transitory computer-readable recording medium according to claim 1, wherein the acquiring includes transmitting the authentication information and acquiring the session information by using an encrypted communication path.

4. An information provision method comprising:
transmitting authentication information to a first server with which a communication session is to be started and acquiring session information from the first server, using a processor; and
transferring the acquired session information to a second server and continuing the communication session with the first server via the second server, using the processor.

5. The information provision method according to claim 4, wherein
the session information is a Cookie, and
the continuing includes transferring the Cookie to the second server.

6. The information provision method according to claim 4, wherein the acquiring includes transmitting the authentication information and acquiring the session information by using an encrypted communication path.

7. An information provision system comprising a first server, a second server, and a client terminal,
the client terminal comprising:
a first access unit that transmits authentication information to the first server and acquires session information from the first server; and
a second access unit that transfers the acquired session information to a second server and requests the first server to provide information via the second server,
the second server comprising:
a request unit that issues a request from the client terminal for the first server to provide information by using the transferred session information; and
a transmitter that transmits a reply from the first server to the request of the request unit to the client terminal.

8. The information provision system according to claim 7, wherein
the session information is a Cookie, and
the second access unit transfers the Cookie to the second server.

9. The information provision system according to claim 7, wherein the first access unit transmits the authentication information and acquires the session information by using an encrypted communication path.
